(19) United States
(12) Patent Application Publication
(10) Pub. No.: US 2002/0120851 A1
(43) Pub. Date: Aug. 29, 2002

(54) Device and method for data timestamping

(76) Inventor: John Richard Clarke, Clevedon (GB)

Correspondence Address: LOWE HAUPTMAN GILMAN & BERNER, LLP, Suite 310, 1700 Diagonal Road, Alexandria, VA, 22314, US

(21) Appl. No.: 10/073,261

(22) Filed: Feb. 13, 2002

(30) Foreign Application Priority Data
Feb. 27, 2001 (GB) 0104815.6

(51) Int. Cl. H04L 9/00

(52) U.S. Cl. 713/178

(57) ABSTRACT

A storage device includes a trusted clock, a memory, a time-stamper and a digital signer. The device is adapted to store to the memory data that has been time-stamped by the time-stamper, with a time obtained from the trusted clock, and digitally signed with a digital signature by the digital signer.

### BACKGROUND OF THE INVENTION

1. Field of the Invention

This invention relates to a device adapted to provide data time-stamping and a method for providing data time-stamping. More particularly, but not exclusively, it relates to a device and method for providing time-stamping without recourse to a trusted third party.

It will be appreciated that any references to data or data set herein relate to amongst other things, but not exclusively, files, data, documents, and software applications.

2. Description of the prior art

Digital time-stamping is a method whereby an element of data, or data set, can be bound to a particular point in time. To minimise the risk that either the data or the time-stamp can be tampered with at a later date a cryptographic digital signature is used to protect both elements. This is clearly of importance when it is important to provide non-repudiable proof of the existence of data, for example in legal matters such as the formation and agreement of a contract or the timing of a revision of a clause of a contract, or of a will. These are just some examples.

Current time-stamping techniques include a method which relies upon the passing of the data to be time-stamped over a network, such as the Internet, to a trusted timeserver incorporating a trusted clock maintained by a trusted third party, as shown in FIG. 1, which time-stamps and digitally signs the data, and sends it back to the originator.

This has security disadvantages in that it involves the transfer over a network, typically the Internet, of the data or time-stamped data which can be intercepted. The data may be altered, re-hashed and sent for time-stamping by the interceptor, thus presenting to a recipient a differently time-stamped data set and associated hash-created digest, which will look correct to the recipient.

Additionally there is the problem of confidence in the trusted third party maintaining the trusted clock. The trusted third party may be certified by an independent Certification Authority. Whilst this gives a high degree of confidence to users, there is a risk that the certificate may be rescinded, expire or be compromised without the immediate knowledge of the users of the trusted data. It will be appreciated that the confidence in the veracity of the timestamp comes from the reputation of the party running the trusted clock and the security of the cryptographic techniques used to sign the hash-created digest.

Remote trusted third party clocks also have a problem of latency (delay) in that a significant amount of time may elapse between the production of data and its time-stamping, it is not an immediate process. There are also limits on throughput in remote trusted third party clocks which can exacerbate the latency problem if the trusted clock forms a constriction in the data flow.

Time-stamping of data by using an internal clock of a computer from which the data originates is generally held to be unacceptable as the internal clock of such computers, such as PC's can be easily altered by simple software alterations.

### GENERAL DESCRIPTION OF THE INVENTION

It is an aim of the present invention to provide a data time-stamping device which ameliorates, at least in part, at least one of the above-mentioned disadvantages or problems.

It is another aim of the present invention to provide a method of data time-stamping which ameliorates, at least in part, at least one of the above-mentioned disadvantages or problems.

According to a first aspect of the present invention there is provided a storage device including a trusted clock, a memory (or storage media), a time-stamper and a digital signer arranged such that the device is adapted to store to the memory data that has been time-stamped by the time-stamper, with a time obtained from the trusted clock, and digitally signed with a digital signature by the digital signer.

It will be understood that the term “trusted clock” relates to a clock, which is believed to be trustworthy, for example a sealed or otherwise tamper-proof clock unit which is physically and logically difficult or impossible to tamper with, or for example a clock which has its time-stamp authenticity certified by a Certification Authority (CA).

It will also be understood that “data storage device” includes a stand alone device, a sub-system, appliance, system, or local distributed memory network, but does not include internet-distributed memory storage.

The digital signature may be encrypted using asymmetrical encryption, for example PKI, or symmetric encryption, for example DES.

The memory will typically be a long term storage medium, not for example a communication channel (e.g. a data bus) or volatile memory e.g. RAM or a temporary buffer. Long term storage media may include, in a non-exhaustive list, CD, DVD, tape, Zip™ disc, magnetic-optical disc, magnetic disc or any recordable solid state memory such as EPROM, Flash, MRAM, EEPROM or solid state device. The memory, or storage media, may be removable from the storage device or alternatively it may be fixed to/within the storage device.

The storage device, apparatus, or system could be a simple storage device such as disc drive or tape drive, or a more complex system such as a disc array, disc sub-system, tape library or optical jukebox; or a disaggregated storage network, a storage area network, or a network attached storage device.

The storage device, apparatus, or system may provide essentially just a storage function, and will in general have no general computational ability or purpose. It will not, for example, be part of the memory of a general purpose server or computer (e.g. not a PC's memory).

There may be a controller associated with the trusted clock. The controller may have controller logic running thereupon. There may be means of checking the veracity of the controller logic The controller logic may be time-stamped. The controller logic may be time-stamped prior to passing data through the trusted clock. The controller logic signature may be checked prior to the time-stamping of data. This prevents the downloading of fake control data into the controller (known as spoofing) thereby preventing alteration of the clock time.

The trusted clock may be mounted upon a plug-in card. The card may be a PCI card. Alternatively the trusted clock may be in the form of a read only device. The clock may have no externally modifiable logic. It may have essentially only an output time signal. A recalibration input, as possibly the only input signal to the clock, is optional.

The data may or may not be encrypted prior to time-stamping. The encryption could take place within the storage device or externally of the device or system prior to time-stamping by the trusted device (clock).

The system may time-stamp all data that it receives for storage. Alternatively the system may include logic that will apply the use of the time-stamping methology to selected elements of the data being time-stamped. There may be a flag which indicates that an element of data is to be time-stamped. This flag may be: 1) embedded within the data itself; 2) provided via the command language used for communication between the storage system or device and a host computer (e.g. a SCSI or filter channel command); or 3) provided via a configuration setting of the storage device or system (e.g. a setting on the controller may be turned to and from “time-stamp” and “do not time-stamp”).

An output of the time-stamper may be a printer thereby producing a non-alterable, physically secure record of the data, or digest, timestamp and signature.

According to a second aspect of the present invention there is provided a method of storing secure time-stamped data on a data storage device comprising the steps of:

(i) providing a trusted clock at the data storage device;

(ii) time-stamping the data at the data storage device;

(iii) creating a digital signature dependent upon the content of the data and the timestamp; and

(iv) storing the data and associated signature on a recording medium of the data storage device.

The digital signature may be encrypted using asymmetric or symmetric encryption. The recording medium may include, in a non-exhaustive list, CD, DVD, Zip™ disc, magnetic-optical disc, magnetic disc or any form of recordable solid state memory such as EPROM, Flash, MRAM, or solid state disc. The storage device, apparatus, or system could be a simple storage device such as disc drive or tape device or a more complex system such as a disc array, disc subsystem, tape library or optical jukebox; or a disaggregated storage network, a storage area network, or network attached storage device. The medium may be removable from the storage device or alternatively may be fixed to/within the storage device.

The trusted clock may be provided upon a plug-in card. The card may be a PCI card. Alternatively the trusted clock may be in the form of a read only device.

The data may or may not be encrypted prior to time-stamping, and the data plus time stamp is generally cryptographically signed.

According to a third aspect of the present invention there is provided a data storage device or system adapted to time-stamp and store data that it receives, the device being connected to a private or public network, and the device being adapted to receive data from a remote source connected to the network and to time-stamp the data and to store the time-stamped data locally at the data storage device or system without transmitting time-stamped data across the network.

Preferably the network may have a plurality of data storage device on it, and at least one of the data storage devices is adapted to time-stamp and store data.

According to a fourth aspect the invention comprises a method of time-stamping and storing data over a public or private network, the method comprising transmitting data to a data storage device attached to the network and time-stamping the data using a trusted clock and storing the time-stamped data at the data storage device without transmitting time-stamped data across the network.

According to a fifth aspect of the present invention, there is provided software, firmware, or a computer readable medium having a program recorded thereupon, which, in use, causes a processor of a data storage device running the program to execute a process in accordance with the second aspect of the present invention; or which when operating in a control processor of a data storage device causes that device to be a device in accordance with the first aspect of the invention; or which when running on a data storage device or system that is network-attached causes the method of the fourth aspect of the invention to be performed, or a network in accordance with the third aspect of the invention to be created.

According to a sixth aspect of the present invention there is provided a data storage device including a trusted clock, the storage device being adapted to store to memory data which has been time-stamped by the clock and which has been digitally signed.

The data storage device may also digitally sign the time-stamped data.

According to a seventh aspect of the present invention there is provided a method of storing time-stamped data on a network comprising transmitting the data from a first device to a data storage device in accordance with the first aspect of the present invention and time-stamping and recording the data at the data storage device in the absence of transmitting the time-stamped data back to the first device for storage.

The invention may have any one or more of the advantages of (i) improving security, i.e. reducing the likelihood of manipulation of the data and timestamp by a third party; (ii) making the time-stamping of data almost instantaneous thereby reducing delays; and (iii) reducing or obviating network bandwidth constraints, increasing throughput of data when compared to the prior art arrangements. The prior art arrangements typically have a trusted clock at a point of a network and other network elements, remote from the clock, transmit their data over the network to the trusted clock where it is time-stamped, signed and transmitted back to its originating network element. The present invention further minimises the bulk movement of data over a network by having time-stamping at the site where data may be stored. Futhermore, there is a reduced chance of the telecommunications link between the data-originating device and the time-stamped data storage device being interrupted if the time-stamped data is stored at or close to where it is time-stamped. This improves connection reliability issues. On congested networks avoiding a “return” transmission leg for the time-stamped data can help avoid loss of packets and can help to reduce congestion.

It will be appreciated that time-stamping can refer to stamping data with a date. It need not, but may, give time in hours, minutes, seconds or subdivisions thereof.

### BRIEF DESCRIPTION OF THE DRAWINGS

The invention will now be described, by way of example, with reference to the accompanying drawings, in which:

FIG. 1 is a schematic diagram of a prior art remote trusted third party time-stamping device;

FIG. 2 is a schematic diagram of a prior art digital signature scheme;

FIG. 3 is a schematic representation of a data time-stamping arrangement according to the present invention;

FIG. 4 is a flow diagram showing a data time-stamping method according to the present invention;

FIG. 5 is a schematic diagram showing a network with storage devices attached thereto; and

FIG. 6 shows another embodiment of the invention.

### DESCRIPTION OF THE PREFERRED EMBODIMENT

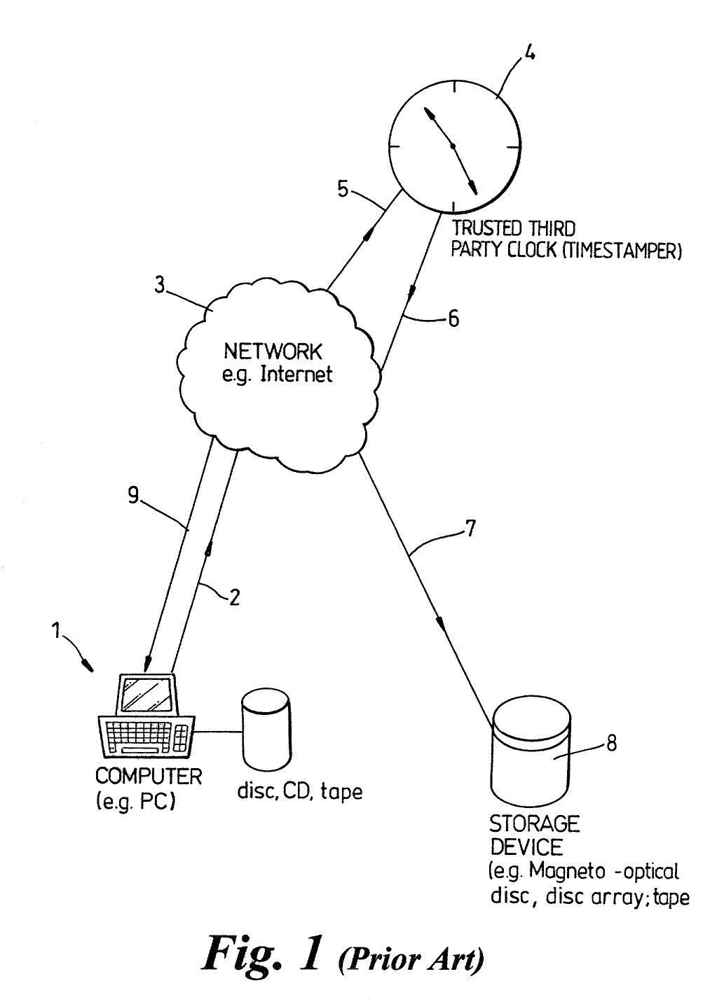

Current trusted third party time-stamping systems, as shown in FIG. 1, involve the transmittal of data over a network to the trusted third party for time-stamping. Data, or a digest of the data, is sent from a computer (e.g. a PC 1) via telecommunications 2 to a network, e.g. the internet 3. The data is routed on the internet 3 to a trusted clock 4 attached to the internet via telecommunications 5 and is time-stamped. Once time-stamped the data may be passed back to the internet via telecommunications 6 and may then be sent via telecommunications 7 to a storage device 8 for storage or it may be sent back to the originator of the data via telecommunications 9 for storage. This introduces delays, has a throughput which is limited by the bandwidth of the network and has opportunities for data interception, connections failures, and falsification of time-stamps.

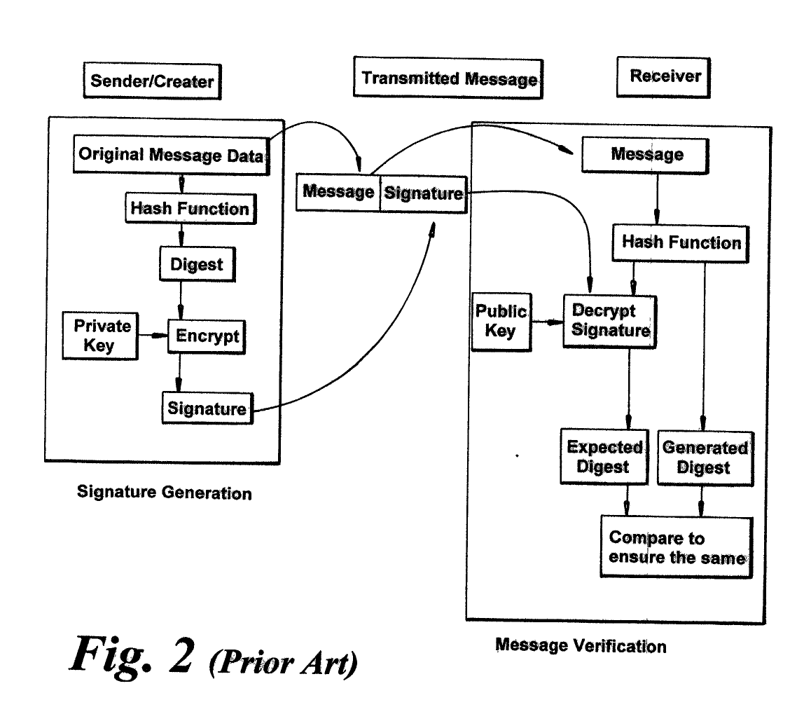

Digital signatures, see for example FIG. 2, reduce the opportunities for data tampering and falsification. This involves passing the data through a hashing algorithm to obtain a digest of the message. A specific digest is almost impossible/very difficult to produce from data other than the original data hashed. The digest is then encrypted using an asymmetric encryption private key to provide a signature. The signature is appended to the data and transmitted with it.

A third party who has the public key which is complementary to the private key used in the encryption process can decrypt the signature to obtain the digest. The third party can rehash the received data and calculate the digest of this. The digest from the signatures and the rehashed digest are compared, if they do not match then the data has been tampered with.

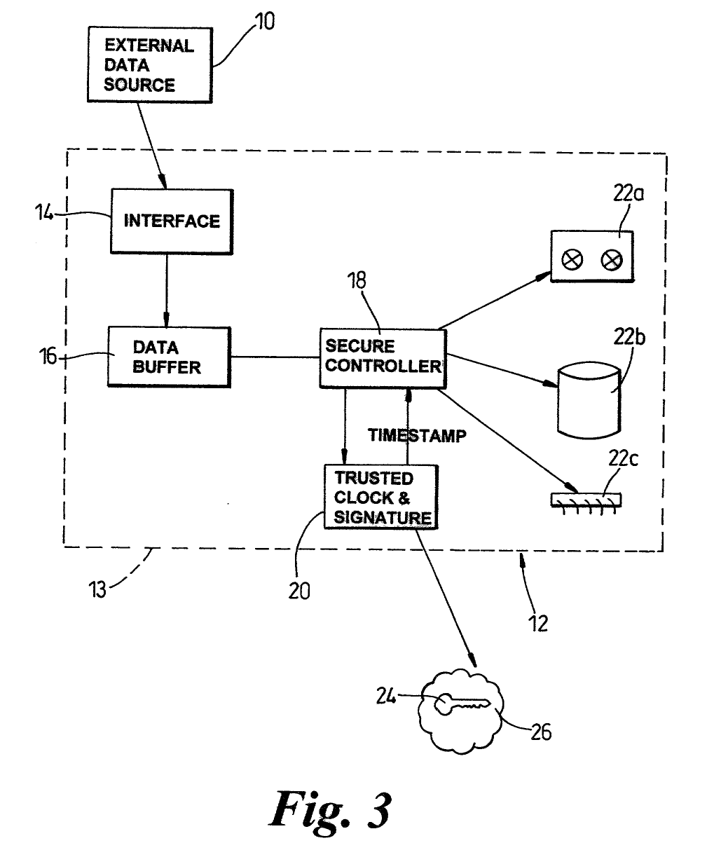

In one embodiment of the present invention, shown in FIG. 3, data from data source 10 is passed into a storage device 12. The storage device 12 (with its boundary shown as 13) comprises an interface 14, a data buffer 16, a secure controller 18 with an associated trusted clock/signature module 20, and data storage media 22, 22b, 22c.

The data from the external data source 10 may or may not be encrypted prior to being passed into the storage device 12. The external data source 10 may be for example a LAN, the Internet, a PC or a server.

The interface 14 serves to ensure interoperability and consistent data handling between different data sources 10 and the storage device 12. The interface 14 may take the form of, for example, an internal bus, SCSI or FiberChannel interface. The SCSI commands may have bespoke data control protocols written into them in order to identify data, data types or data sets which require time-stamping.

The data buffer 16 maintains a steady and consistent data transfer rate to the controller 18. The buffer 16 is typically a piece of memory.

The secure controller 18 controls the formatting and preparation of data prior to their recording on the media 22a, 22b, 22c. This can include blocking and compression of the data.

The data passed to the controller 18 will typically have a flag set which identifies it as requiring time-stamping or not. The controller 18 then either filters out data flagged “time-stamp me” and passes only (or substantially only) the data with the flag set to ‘timestamp’ to the trusted clock module 20 for time-stamping, or it sends all of the data to the trusted clock which only time-stamps flagged data.

The controller 18 may also control the trusted clock 20. Control logic for the controller 18 may be protected by a separate trust mechanism. This may allow the veracity and/or origin of the logic to be checked and may aid in the detection of downloaded fake control logic.

The trusted clock module 20 timestamps and digitally signs the data in a conventional manner, for example using DSA, and passes the data back to the controller 20, along with the signature. As will be appreciated, the data could be a digest or signature of a larger set of data. The controller 18 contains a checking routine to confirm that the time-stamping is successful. If it is not correctly time-stamped the data is passed back to the trusted clock module 20 for retime-stamping. The controller 18 writes the data timestamp and signature to storage media 22a, 22b, 22c, either in a single block or in a fragmented form. If it is written in a fragmented form, there must be data control logic provided in order to locate the fragments.

A public key 24 which, corresponds to the private key used in the digital signing of the data is placed on a network 26. A recipient of the data can obtain the public key 24 from the network 26 or it can be sent to them either via E-mail or on media.

It will be appreciated that the public key need not be ‘published’ but may be retained by the author of the data for their own use, or disseminated to a restricted group of people/entities.

The trusted clock module 20 is typically hardwired into the storage device 12 in order to reduce the likelihood of tampering and bogus insertions of clocks into devices. The clock module 20 may be made tamperproof and/or tamper evident by any convenient method (for example it may be encased in resin or other suitable material to prevent/indicate attempts to access it physically). It is recommended that the trusted clock 20 is certified by a trusted CA, but this is not essential. Other ways of having a trusted clock exist (e.g. an encapsulated clock which cannot be altered and can only output the date and time).

Provision may made for the replacement of the trusted clock 20 at the expiry of the certificate (e.g. or plug in/out clock module), or authorised service personnel may be capable of removing an encapsulated hardwired clock and replacing it with another, possibly requiring security access codes to disable anti-forgery protection logic. Alternatively it may be possible to upload a new certificate into the clock.

Provision may be made for the correction of drift of the trusted clock. For example, the clock may be arranged to synchronise itself with a trusted time signal periodically (e.g. with a satellite clock signal).

An alternative to the hardwiring of the clock module 20 is the use of a removable clock module, for example an insertable plug in-plug out cards containing the clock module. This increases the risk of tampering but has the advantage of ease of maintenance and replaceability upon the expiry of a certificate period for a particular clock module.

The storage device 13 may be a disc drive, or a tape drive, having no general purpose computing ability, and not being programmable for tasks other than storing and/or retrieving data (with time-stamping and possibly signature generation facilities). Alternatively, whilst still having functionality limited to being essentially a data storage device, it may be more complex such as an array of linked memory stores.

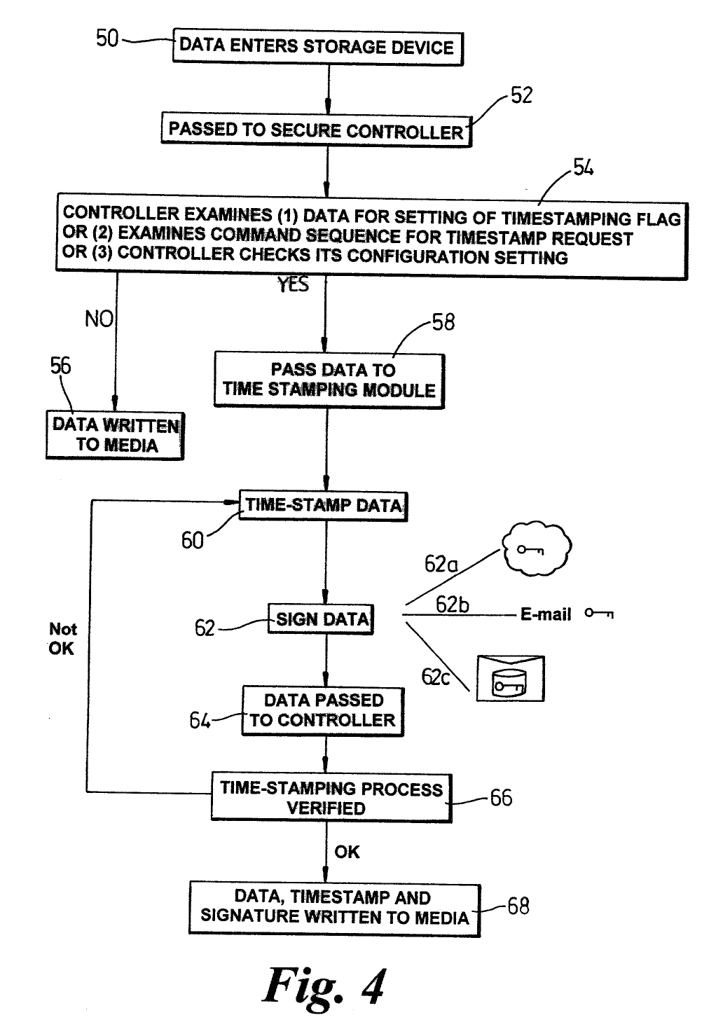

FIG. 4 is a flow diagram of a method of time-stamping of data.

Data enters a storage device (Step 50) and is passed to the controller (Step 52). The controller examines the data to see if a flag is present, or if a flag has been set in the command sequence for time-stamping of the data, or if the controller has been configured for time-stamping (Step 54). If the flag is not set to time-stamp the data it is written to storage media (Step 56).

If the flag is set to time-stamp the data it is passed to the time-stamping module (Step 58). The data is time-stamped (Step 60) and a digital signature effectively scaling the digital time-stamp to the data content, is applied (Step 62). A public key corresponding to this signature process can be placed on a network (Step 62a), e-mailed to a recipient of the data (Step 62b) or stored on media and mailed to a recipient of the data (Step 62c).

Alternatively, the public key can be recorded manually, not published at all, or published at any stage of the process.

The data timestamp and signature are then passed back to the controller (Step 64) and the time-stamping process is verified (Step 66). The data, time-stamp, and signature are then written to media (Step 68).

The coupling of the time-stamping features with a storage device ensures that data can always be securely written by this device and does not depend upon the application hosting server to provide secure data management. This is particularly useful in storage architectures which physically and logically separate storage systems from application servers, e.g. storage area networks and network attached storage devices. All data written by the storage device can be content integrity checked and date/time of creation verified at a later date by decrypting and validation of the related signed time-stamp.

As can be seen from FIG. 5, the present invention can reduce network traffic by removing the need to pass time-stamped data back across the network as it is time-stamped at the point at which it is stored.

FIG. 5 shows a data originator 80 (e.g. computer, such as PC) connected to the Internet 81 via public telecommunications 82. Data to be time-stamped, signed and stored by a trusted clock data storage device is transmitted via public telecommunications 83 or 84 to a data storage device 85 or 86. In case of storage device 85, the trusted clock, signing capability, and physical data store are all in one physical device, device 85, and the data is time-stamped signed and stored in device 85. In the case of device 86, the trusted clock and signing unit are in one physical box 87 and the memory is in another 88, or the memory may even be distributed memory 89 in a local network (not back out on the internet). This memory could be disc or tape-based, or chip based. Of course, whilst the time-stamping and signing can be performed in the same “box”, e.g. box 87, the signing could be in a different physical unit than the time-stamping, either in its own unit, or in the memory unit (still not requiring further access to the internet).

Data need only be passed to the time-stamping device and need not be passed back over the network once time-stamped for storage as the time-stamper and storage device (assembly, apparatus or system) are the same.

If the network is set up exclusively for the purpose of time-stamping network traffic can be halved. If it is a general purpose network the network traffic associated with time-stamping can still be significantly reduced.

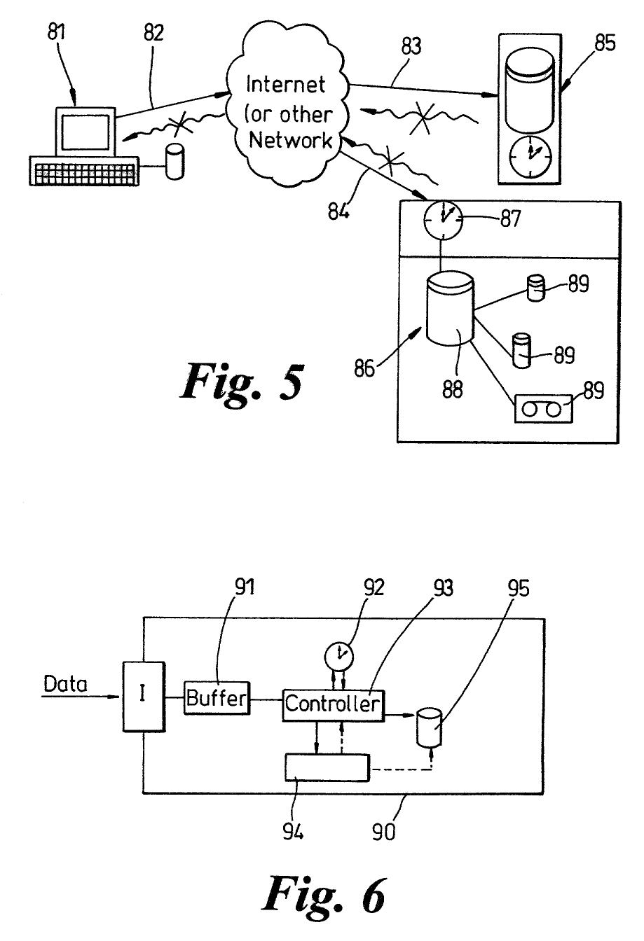

FIG. 6 shows a data storage device 90 having an interface I, a buffer 91, a trusted clock time-stamper 92, a controller 93, a signer 94, and a memory store 95. The controller 93 receives data from the buffer, decides what part of the data is to be time-stamped and sends that to the trusted clock 92 and receives back time-stamped data. The controller then sends the time-stamped data to the signer which signs it (creates a digest and encrypts the digest to create a signature). The signer then sends the signed time-stamped data back to the controller which sends it to memory 95 for storage.

In modified versions the signer could send the signed time-stamped data to the memory 95 without going through the controller. The clock 92 could send time-stamped data straight to the signer without going through the controller.

It will be appreciated that the controller may send all data to the clock for time-stamping, or just some data, e.g. selected types of data/selected parts of data. The time-stamper may stamp all data that it receives, or only some of the data that it receives. Data that is not time-stamped may or may not be recorded to memory.

Instead of the signing happening in the clock unit itself, it could occur externally of the clock unit, but still within the data storage device.

It will be appreciated that having a trusted clock attached to the data memory store provides the shortest path post-time-stamping/signing, which provides the least opportunity for attack on the integrity of the data and/or timestamp, and the least opportunity for breakdowns or bottlenecks in external telecommunication systems to hinder the time-stamping and storage operation. Problems with congested networks hindering acquisition of a timestamp are similarly reduced if, once received by the data storage system, the data does not have to go back out on an external network (e.g. the internet) for time-stamping and signing. Similarly, once time-stamped the data does not have to be subjected to Internet congestion/transmission problems before it is stored.

In some embodiments the trusted clock may be a device with a resonating crystal specifically intended for timekeeping. In other devices the clock may be a software clock, which may make use of the clock-speed of a processor chip. In either case, correction for drift of the clock may be possible, for example synchronisation with an external clock signal (e.g. another trusted clock), possibly by wireless communication, possibly by wired (e.g. temporarily wired) connection.

1. A storage device including a trusted clock, a memory, a time-stamper and a digital signer, the device being adapted in use to store to said memory data that has been time-stamped by said time-stamper, with a time obtained from said trusted clock, and digitally signed with a digital signature by said digital signer.

2. A device as claimed in claim 1 wherein said memory comprises either of the following: a disc, a tape drive.

3. A device as claimed in claim 1 wherein said memory is a long term storage medium.

4. A device as claimed in claim 1 wherein said memory is removable from the storage device.

5. A device as claimed in claim 1 wherein said device comprises a part of any one of the following: a disc drive, a tape drive, a disc array, a disc sub-system, a tape library, an optical jukebox, a disaggregated storage network, a storage area network, network attached storage.

6. A device as claimed in claim 1 wherein said trusted clock is provided by a card adapted to be plugged into said device.

7. A device as claimed in claim 1 wherein said trusted clock is an encapsulated hardwired component.

8. A device as claimed in claim 1 wherein there is a controller, with associated controller logic, said controller logic being protected by a trusted mechanism to prevent unauthorised and unnoticed alteration of said controller logic.

9. A device as claimed in claim 1 wherein said device has a controller adapted to do at least one of the following: identify whether data received by said device has a flag indicative as a command to time-stamp flagged data, identify whether command language used to control operation of said device has a marker indicative as a command to time-stamp selected data, check whether the time-stamper is set to a time-stamp mode to time-stamp received data, or not, so set so as not to time-stamp data.

10. A device as claimed in claim 1 further comprising a clock-correcting input adapted to input a trusted correction signal to said trusted clock to correct said clock.

11. A device as claimed in claim 1 which has no significant functional capability beyond that claimed in claim 1 and which is incapable of general computational activities.

12. A storage device including a trusted clock; a long term memory device; a time-stamper; a digital signing unit; and a controller, with associated controller logic: said device being adapted, in use, to store to said memory device data that has been time-stamped by said time-stamper with a time obtained from said trusted clock and digitally signed with a digital signature by said digital signing unit, and said controller logic being protected by a trusted mechanism to prevent, in use, unauthorised alteration of said controller logic.

13. A storage device including trusted clock means for non-repudiably measuring time, data storage means for storing data, time-stamping means for stamping data with a non-repudiable time supplied by said trusted clock means, digital signing means for signing data digitally such that said data storage means stores data that has been time-stamped by said time-stamping means and signed with a digital signature by said digital signing means, in use.

14. A method of storing secure time-stamped data comprising the steps of:
(i) providing a data storage device;
(ii) providing a trusted clock at said data storage device;
(iii) time-stamping data at said data storage device;
(iv) creating a digital signature dependent upon content of said data and time-stamp; and
(v) storing said data and associated said signature on a recording medium of said data storage device.

15. A method as claimed in claim 14 wherein said data storage device comprises a long-term data storage medium and wherein time-stamped, signed data is stored on said long-term data storage medium.

16. A method as claimed in claim 14 wherein a controller is used to control operations (iii) to (v), and wherein said controller is controlled by control logic, and wherein said control logic is protected by a trusted mechanism which ensures that said control logic has not been modified from what it should be.

17. A method as claimed in claim 14 wherein data received by said data storage device is checked for a flag indicative of instructions to time-stamp all of or a selected part of said data, and said data, or the part of said data, is time-stamped accordingly.

18. A method as claimed in claim 14 wherein a command language of a controller is checked for instructions to time-stamp all, or a selected part, or parts, of said data.

19. A method as claimed in claim 14 wherein said device is controlled by a controller which has a time-stamp setting in which the time-stamper time-stamps said data and a non time-stamping setting in which the time-stamper does not time-stamp said data, and in which a check is made as to the setting of said controller prior to said time-stamping, or not, of received said data.

20. A method as claimed in claim 14 comprising transmitting said data to said device over the Internet or other public network, and time-stamping and signing said data, and storing said time-stamped signed data, within said data storage device without transmitting said signed data back over the Internet or other public network.

21. A method as claimed in claim 14 wherein said data that is time-stamped is a digest of a larger data record.

22. A method of storing secure time-stamped data comprising the steps of:
(i) providing a data storage device having a long term data storage medium;
(ii) providing a trusted clock at said data storage device;
(iii) providing a controller at said storage device, with associated control logic that is protected by a trusted mechanism;
(iv) time-stamping said data at said data storage device, under the control of said controller;
(v) creating a digital signature dependent upon content of said data and time-stamp, under the control of said controller; and
(vi) storing said data and associated signature on said long term data storage medium of the data storage device, under the control of said controller.

23. A network having a data storage device adapted to time-stamp and store data that it receives from said network without transmitting time-stamped data across said network.

24. Software, firmware or a computer readable medium having a program recorded thereupon which, in use, causes a processor of a data storage device running a program to execute a process comprising the steps of:
i) time-stamping data at said data storage device;
ii) creating a digital signature dependent upon content of said data and time-stamp; and
iii) storing said data and associated said signature on a recording medium of said data storage device.

25. Software, firmware or a computer readable medium having a program recorded thereupon which when operable upon a control processor of a data storage device causes the device to operate as a device including a trusted clock, a memory, a time-stamper and a digital signer, the device being adapted, in use, to store to said memory data that has been time-stamped by said time-stamper, with a time obtained from said trusted clock and digitally signed with a digital signature by said digital signer.

26. A method of storing time-stamper data on a network comprising transmitting the data from a first, remote, network-attached device to a data storage device, the data storage device including a trusted clock a memory, a time-stamper and a digital signer, the device being adapted, in use, to store to said memory data that has been time-stamped by said time-stamper, with a time obtained from said trusted clock and digitally signed with a digital signature by said digital signer, in the absence of transmitting time-stamped data back to said remote device for storage.
